(19) United States
(12) Patent Application Publication
(10) Pub. No.: US 2005/0208383 A1
(43) Pub. Date: Sep. 22, 2005

(54) Electronic component separator and method for producing the same

(76) Inventors: Hiroki Totsuka, Shizuoka-shi (JP); Masahide Sugiyama, Shizuoka-shi (JP); Masanori Takahata, Shizuoka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/081,396

(22) Filed: Mar. 16, 2005

(30) Foreign Application Priority Data
Mar. 19, 2004 (JP) 2004-080295
Apr. 7, 2004 (JP) 2004-112702

(51) Int. Cl. H01M 2/16

(52) U.S. Cl. 429/247; 429/1; 429/248

(57) ABSTRACT

The present invention provides a separator that, when used in a lithium ion secondary battery, polymer lithium secondary battery, aluminum electrolytic capacitor or electric double-layer capacitor, offers desired levels of various practical characteristics, undergoes minimal heat shrinkage even when overheated, and exhibits high reliability and excellent workability. The electronic component separator proposed by the present invention comprises a porous base made of a substance having a melting point of 180° C. or above, and a resin structure provided on at least one side of and/or inside the porous base, and the porous base and/or resin structure contains filler grains.

### BACKGROUND OF THE INVENTION

1. Field of the Invention

This invention relates to an electronic component separator that can be used favorably in electronic components, such as lithium ion secondary batteries, polymer lithium secondary batteries, lithium metal batteries, aluminum electrolytic capacitors and electric double-layer capacitors, or more favorably in large lithium batteries and electric double-layer capacitors requiring higher heat resistance, as well as a method for producing the same.

2. Description of the Background Art

In recent years, demands for such electronic components as lithium ion secondary batteries, polymer lithium secondary batteries, aluminum electrolytic capacitors and electric double-layer capacitors are growing significantly in both industrial and commercial applications, partly due to the rising demands for electrical/electronic equipment, and partly due to the development of hybrid vehicles. Electrical/electronic equipment are rapidly advancing to offer higher functions in smaller packages, and accordingly the market is demanding lithium ion secondary batteries, polymer lithium secondary batteries, aluminum electrolytic capacitors and electric double-layer capacitors also offering higher functions in smaller packages.

Lithium ion secondary batteries and polymer lithium secondary batteries have a common structure, which is described as follows: First, active material and lithium-containing oxide are mixed with a binder such as polyvinylidene fluoride in a 1-methyl-2-pyrrolidone, and then the mixture is formed into a sheet on an aluminum collector to obtain a positive electrode. Next, carbon material capable of occluding/releasing lithium ions is mixed with a binder such as polyvinylidene fluoride in a 1-methyl-2-pyrrolidone, and then the mixture is formed into a sheet on a copper collector to obtain a negative electrode. Then, a porous electrolyte film made of polyvinylidene fluoride, polyethylene, etc., is prepared, and the positive electrode, electrolyte film and negative electrode are rolled or laminated in this order to obtain an electrode body. This electrode body is impregnated with a driving electrolyte solution and then sealed in an aluminum case. The structure of an aluminum electrolytic capacitor is as follows: An etched positive electrode foil made of aluminum, on which a dielectric film is formed via chemical conversion, and an etched negative electrode foil made of aluminum, are rolled or laminated via a separator to obtain an electrode body. This electrode body is soaked in a driving electrolyte solution, sealed in an aluminum case and sealing material, and then the positive lead and negative lead are taken out through the sealing material in a manner preventing short-circuiting. The structure of an electric double-layer capacitor is as follows: A mixture of active carbon, conductive agent and binder is pasted on both sides of positive and negative aluminum collector electrodes, and the electrodes are rolled or laminated via a separator to obtain an electrode body. This electrode body is impregnated with a driving electrolyte solution, packed in an aluminum case and sealing material, and then the positive lead and negative lead are taken out through the sealing material in a manner preventing short-circuiting.

Traditionally, separators used in the aforementioned lithium ion secondary batteries and polymer lithium secondary batteries are porous films or non-woven fabrics made of polyolefins such as polyvinylidene fluoride and polyethylene, polyester, polyamide, polyimide, and so on. Separators used in the aforementioned aluminum electrolytic capacitors and electric double-layer capacitors use papers made of cellulose pulp or non-woven fabrics made of cellulose fibers, polyester fibers, polyethylene terephthalate fibers, acrylic fibers, and so on.

In the meantime, the aforementioned lithium ion secondary batteries, polymer lithium secondary batteries, aluminum electrolytic capacitors and electric double-layer capacitors are becoming increasingly smaller, as mentioned above, and therefore separators used in these products are also met with a demand for reduced film thickness. However, reducing the film thickness of conventional separators will cause minor short-circuiting between the positive and negative electrodes or affect the separator's ability to retain a sufficient amount of driving electrolyte solution needed to drive the electronic component. In addition, mechanical strength will also drop, which will lead to various problems such as lower operability and yield in the production process and an eventual drop in product reliability. One way to ensure sufficient mechanical strength of a thinner separator is to reduce its porosity. If porosity is reduced, however, internal resistance will increase to levels at which the separator will no longer satisfy the high-function requirements.

On the other hand, secondary batteries having a relatively high energy density, such as lithium ion secondary batteries and lithium polymer secondary batteries, are finding their way into onboard devices for automobiles as well as storage elements in cogeneration systems. However, onboard devices for automobiles have a relatively high operating temperature range and are also subject to temperature rise when used continuously at high rates. As a result, these devices demand higher heat resistance and stability than what has been required for conventional separators. Polyolefin resin separators, which represent the mainstream separator specification at the present, are unable to meet this requirement. To be specific, polyolefin resin separators must be designed to melt at approx. 120 to 130° C. and thereby suppress ion conductance in order to ensure safety in the event of overheating. Therefore, these separators are prone to shrinkage in a high-temperature environment. One way to suppress this shrinkage is the technology disclosed in Publication of Unexamined Patent Application No. 2003-317693, which is to combine a non-woven fabric offering good heat resistance with polyethylene grains or fibers, etc., in order to provide a shutdown function while suppressing shrinkage at the same time. This patent literature claims that filler grains such as polyethylene grains exhibit a shutdown function more readily when segregated. However, segregated filler grains detach and drop more easily, particularly during their handling in the production process, etc. As a result, areas from which the filler grains have detached/dropped are likely to become coating defects and lead to pinholes or other separator defects. Additionally, a non-woven fabric made with fibers of low melting points shrinks more easily and may pose other problems.

Gazette of International Publication No. WO 01/67536 proposes a separator comprising a microporous resin film (stretched film) offering relatively high air permeability, which is made by drawing polyolefin and then adding through pores by means of a puncture needle or laser. However, this patent literature gives no considerations to the diameter of through pores, distance between adjacent through pores, separator film thickness, and so on. A microporous polyolefin resin film such as the one proposed in this patent literature is inherently prone to some degree of shrinkage in a meltdown temperature range corresponding to or above the shutdown temperature. As a result, this microporous polyolefin resin film easily causes short-circuiting between the electrodes. Here, “shutdown” refers to a phenomenon of suspended current flow, which is caused by blocked micropores in the separator at temperatures of approx. 140 to 150° C. due to abnormal rise in the internal temperature of the battery.

### SUMMARY OF THE INVENTION

The present invention was proposed in view of the current situations mentioned above and aims to provide an electronic component separator that, when used in a lithium ion secondary battery, polymer lithium secondary battery, aluminum electrolytic capacitor or electric double-layer capacitor, offers desired levels of various practical characteristics, undergoes minimal heat shrinkage even when overheated, and exhibits high reliability and excellent workability, as well as a cost-effective method for producing the electronic component separator.

In order to achieve the above aim, the electronic component separator proposed by the present invention comprises a porous base made of a substance having a melting point of 180° C. or above, and a resin structure provided on at least one side of and/or inside the porous base, and contains filler grains.

A desired mode of the electronic component separator proposed by the present invention is one in which the aforementioned porous base is a microporous resin film that has through pores with an average pore diameter of 50 μm or less, formed in the direction vertical to the film surface in a manner virtually free from any shielding structure and keeping an average minimum distance of 100 μm or less between adjacent through pores; a resin structure is provided on at least one side and/or inside the porous base; and filler grains are contained.

The electrode-integrated electronic component separator proposed by the present invention comprises a porous base made of a substance having a melting point of 180° C. or above, and a resin structure provided on at least one side of and/or inside the porous base, which are being formed on top of an active electrode layer comprising a collector and an active layer, and having a separator containing filler grains.

The method for producing the electronic component separator as proposed by the present invention is characterized by the application on a porous base made of a substance having a melting point of 180° C. or above and containing filler grains, a coating material that contains a resin for forming a porous resin structure, followed by the drying of the coating material to form porous resin structure on the surface of and/or inside the porous base.

### BRIEF DESCRIPTION OF THE DRAWING

FIG. 1 is a schematic section drawing illustrating an example of the electronic component separator proposed by the present invention.

FIG. 2 is a drawing explaining the condition of through pores in the microporous resin film.

FIG. 3 is a schematic section drawing illustrating an example of the microporous resin film used in the present invention.

FIG. 4 is a schematic section drawing illustrating filler grains contained in the through pores in the microporous resin film.

FIG. 5 is a schematic section drawing illustrating the electronic component separator obtained in Example 14 in conformance with the present invention.

FIG. 6 is a schematic section drawing illustrating the electronic component separator obtained in Example 18 in conformance with the present invention.

FIG. 7 is a schematic section drawing illustrating the electronic component separator obtained in Example 19 in conformance with the present invention.

FIG. 8 is a schematic section drawing illustrating the electronic component separator obtained in Example 20 in conformance with the present invention.

1—Microporous resin film, 1a—Through pore, 2—Filler grain, 3—Porous structure

### DETAILED DESCRIPTION OF THE INVENTION

The porous base of the electronic component separator proposed by the present invention comprises a substance having a melting point of 180° C. or above. Specific examples of such substance include: papers made of cellulose pulp; papers made of cellulose fibers (including bast fibers such as cotton, hemp and jute and vein fibers such as manila hemp); and non-woven fabrics and netlike substances made of regenerated fibers (including regenerated cellulose fibers such as rayon and cupra and regenerated protein fibers), semi-synthetic fibers (including cellulose acetate fibers and promixes), nylon, aramid fibers, polyester fibers (including, polyethylene terephthalate fibers and polyethylene naphthalate fibers), acrylic fibers, polyolefin fibers (including polyethylene and polypropylene), vinylon fibers (including polyvinyl alcohol fibers), polyvinyl chloride fibers, polyvinylidene chloride fibers, polyurethane fibers, polyoxymethylene fibers, polytetrafluoroethylene fibers, polyparaphenylene-bisthiazole fibers, polyimide fibers and polyamide fibers, ceramic fibers, metal fibers, and so on.

Another specific mode of the present invention is a microporous resin film made of a substance comprising any of the above fibers, wherein such film has only through pores formed in the direction vertical to the film surface in a manner virtually free from any shielding structure and connecting one side of the film to the other side. A preferable mode is a microporous resin film having through pores with an average pore diameter of 50 μm or less, formed in the direction vertical to the film surface in a manner virtually free from any shielding structure, with the average minimum distance between adjacent through pores adjusted to 100 μm or less.

The aforementioned non-woven fabrics can be produced using known technologies, such as the wet method, dry method, wet pulp method, spunbond method, melt blow method, flash spun method and tow opening method. In addition, microporous resin films having through pores can be produced using the method of forming pores in a resin film via laser irradiation. The substance comprising the aforementioned porous base used in the present invention must have a melting point of 180° C. or above. If the melting point is below 180° C., the material will melt when heated and shrink easily, which can lead to a problem of short-circuiting between the electrodes.

If a microporous resin film is to be used as the porous base in the present invention, a microporous resin film made of any one of polyester, polyimide and polytetrafluoroethylene can be used favorably. However, the choice is not limited to these resins and any resin can be used as long as it undergoes minimal heat shrinkage and does not dissolve in the organic solvent or ionic fluid used as the electrolyte solution. Among the various polyesters, polyethylene terephthalate is especially desirable, because it does not melt when heated to the aforementioned temperature range, undergoes minimal heat shrinkage, and does not cause short-circuiting between the electrodes in a relatively high temperature range. In addition, polyethylene naphthalate (PEN), polytetrafluoroethylene and polyimide can also be used favorably in the present invention, because they provide good resistance to electrolyte solutions and ionic fluids as well as excellent resistance to heat shrinkage. Furthermore, the microporous resin film used in the present invention should preferably have only through pores.

FIG. 2 explains through pores in a microporous resin film. FIG. 2A shows a top view of a microporous film, while FIG. 2B and FIG. 2C show a section view and an enlarged top view of the same film, respectively. In the present invention, the average diameter of through pores in the microporous resin film (a in FIG. 2C) should preferably be 50 μm or less, or more preferably be in a range of 0.1 to 30 μm. If pore diameter a is less than 0.01 μm, ion conductance will be inhibited easily. If pore diameter a exceeds 50 μm, on the other hand, short-circuiting will occur easily even in a normal use environment of electronic components, even after the film has been joined with a porous structure as explained later.

In the present invention, the average minimum distance between adjacent through pores in the microporous resin film (b in FIG. 2C) should preferably be 100 μm or less, or more preferably be in a range of 0.1 to 50 μm. If filler grains are used as explained later, the relationship of minimum distance b between adjacent through pores and the primary average grain size of filler grains must be considered. In general, if average minimum distance b is less than 0.01 μm, the microporous resin film may break easily during the rolling process due to insufficient mechanical strength. If average minimum distance b exceeds 100 μm, the aforementioned problem of mechanical strength should not occur. However, if the diameters of through pores are small, ion conductance may drop.

In the present invention, the average diameter of through pores and average minimum distance between adjacent through pores were measured as follows. As for the average diameter of through pores, through pores in the microporous resin film were observed by an electron microscope to randomly sample 100 through pores, and the average diameter of the sampled pores was calculated. Similarly for the minimum distance between adjacent through pores, 100 through pores were randomly selected in the same manner, and the average minimum distance between the sampled pores was calculated.

The film thickness of the porous base used in the present invention can be determined as deemed appropriate for a given purpose of use of the separator. In recent years, batteries are met with a demand to make the electrodes as thick as possible to support the increasing battery capacities. To offset the volume increase due to thicker electrodes with a thinner separator, the microporous resin film composing the porous base should preferably have a film thickness of 20 μm or less. If a large amount of electrolyte solution must be retained in the electronic component, such as in the case of an electric double-layer capacitor, the film thickness may need to be increased further from the above level.

In the present invention, a resin structure is provided on at least one side of the aforementioned porous base or inside the porous base, or on at least one side of and inside the porous base. Specific examples of resins that can compose this resin structure include one or more of polyvinylidene fluoride, vinylidene fluoride copolymer, polyacrylonitrile, acrylonitrile copolymer, poly(methyl methacrylate), methyl methacrylate copolymer, polystyrene, styrene copolymer, polyethylene oxide, ethylene oxide copolymer, polyimide amide, polyphenylsulfone, polyethersulfone, polyether etherketone, and polytetrafluoroethylene. These resins can be produced using known technologies. In the case of homopolymers, component resin monomers can be reacted together through any form of addition polymerization, such as radical polymerization, cation polymerization, anion polymerization, optical/radiation polymerization, suspension polymerization, emulsion polymerization or block polymerization. In the case of copolymers, component resin monomers and other monomers can be copolymerized through the same polymerization methods mentioned above.

In the present invention, the resin composing the aforementioned resin structure should preferably have a melting point of 145° C. or above. If the melting point is below 145° C., the resin structure may melt when heated and block the pores in the porous base. If the material resin dissolves or gelatinizes easily in the electrolyte solution, this blocking characteristic will further increase and may eventually cause battery performance to drop.

In the present invention, the resin used to form the aforementioned resin structure should preferably be soluble in amide solvents, ketone solvents or furan solvents. Vinylidene fluoride resins that can be used particularly favorably in the present invention exhibit a very good film production property when dissolved in amide solvents, which makes these resins particularly desirable. To improve drying efficiency of the coated surface, however, use of resins soluble in ketone solvents or furan solvents is ideal. In the present invention, two or more of the aforementioned solvents can be mixed as deemed appropriate, by considering the effects on drying speed and film production condition.

In the present invention, the aforementioned resin structure should preferably be porous. If the resin structure is not porous, extractability of electrolyte solution will drop along with ion conductance. Each pore in the aforementioned porous resin structure should desirably have a series of many pores linked together to connect one side of the separator to the other side, and the diameter of each pore should desirably be smaller than the film thickness of the separator. If the pore diameter is equivalent to or greater than the film thickness of the separator, minor short-circuiting will occur easily and the battery yield may drop.

In the present invention, the diameter of pores in the porous structure should be in a range of 0.1 to 15 μm, or more preferably 0.5 to 5 μm, as measured by the bubble point method. If the pore diameter is smaller than 0.1 μm, ion conductance may be inhibited. Also, the ability to impregnate electrolyte solution will likely drop and growth of micro dendrite may be inhibited. If the pore diameter is greater than 15 μm, problems such as short-circuiting may occur, especially when the separator thickness is reduced.

In the present invention, filler grains are contained on at least one side of and/or inside the aforementioned microporous resin film or porous structure. The material for filler grains may be inorganic or organic, as long as it has resistance to organic electrolyte solutions and ionic fluids. However, filler grains made of organic compounds are desirable from the viewpoints of uniformity in their shape and grain size distribution. Uniform shape and grain size are an important aspect of the present invention, along with the pore diameter design of the aforementioned through pores.

In the present invention, heat resistance of the separator can be improved by using filler grains having a melting point of 180° C. or above or virtually no melting point. If the melting point of filler grains is lower than 180° C., the grains may melt when heated and block the pores in the porous structure, eventually causing battery performance to drop. If filler grains are made of a material that dissolves or gelatinizes easily in the electrolyte solution, pores will be blocked more easily, which is not desirable. The aforementioned filler grains may be fine grains of polytetrafluoroethylene (PTFE), bridged polymethyl methacrylate (PMMA), silica, alumina, benzoguanamine, nylon, glass, silicone, bridged styrene, polyurethane, and so on. These fine grains should preferably have a primary average grain size of 10 μm or less.

If the porous base is made of a microporous resin film, use of polyolefin resin grains, such as grains made of polyethylene or polypropylene, will add a shutdown characteristic. This is because when these grains are filled in the aforementioned through pores or pores in the porous structure, these grains will melt when heated to a specified temperature to block the pores, thereby preventing the electrochemical reaction from occurring uncontrollably. In this case, however, it is desirable to use a combination of two or more types of filler grains having different softening points.

The content of filler grains should be 0.5 to 100 g/m², or more preferably 50 g/m² or less, with respect to the porous base. Specification of the lower limit may not be necessary in the present invention, but use of filler grains in a content of less than 1 g/m² may reduce the shutdown effect that contributes to battery stability. Therefore, the content of filler grains should be kept to a range of 1 to 50 g/m², or more preferably 1 to 30 g/m².

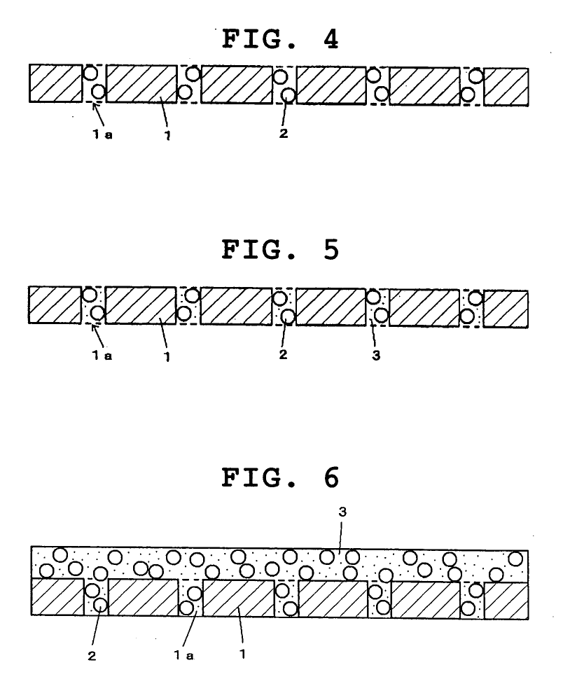

If the porous base in the present invention is made of a microporous resin film, implementing dimensional controls with respect to the diameter of through pores and that of pores in the porous structure as well as primary grain size of filler grains plays a very important role in the improvement of ion conductance and overcharge resistance. In the present invention, the primary average grain size of filler grains should desirably be 0.1 to 95% of the diameter of through pores or pores, whichever is smaller. If this value is lower than 0.1%, filler grains will melt when the internal temperature of the battery rises above a normal use range, in which case blocking the pores in the porous structure and through pores in the microporous resin film will become difficult and battery safety may be compromised as a result. If the above value is higher than 95%, on the other hand, the clearances between separator pores and through pores may be reduced. This can affect ion conductance and various other characteristics that determine battery performance. Also, the filler grains may inhibit the growth of micro dendrite and thus remove the beneficial effect of micro dendrite on overcharge resistance. In other words, the present invention makes it possible to design a separator that does not inhibit the formation of micro dendrite having the effect of preventing overcharge nor minor short-circuiting between the electrodes, by designing the primary grain size of filler grains in such a way that appropriate clearances will be provided between the pores in the porous structure or through pores. FIG. 4 explains the above condition by providing a schematic section view of a microporous resin film (1) with its through pores (1a) filled with filler grains (2). In the present invention, the primary average grain size refers to an average of long and short diameters of 100 grains sampled on a SEM photograph.

As explained above, if the porous base in the present invention is made of a microporous resin film, pores in the porous structure and through pores will not be blocked in a condition of normal use temperatures and therefore a level of battery performance equivalent to or better than what is achieved by conventional separators can be ensured, so long as the primary average grain size of filler grains is designed slightly smaller than the diameter of pores in such porous structure or diameter of through pores. In addition, another effect of the present invention is a higher separator density resulting from the existence of filler grains. This provides excellent benefits not available with traditional single-layer or multi-layer film separators made only of a porous structure not containing filler grains or a combination of non-woven fabric and porous structure. In other words, short-circuiting that would occur frequently in a thin separator with a film thickness of 20 μm or less no longer occurs in the separator containing filler grains as proposed by the present invention. As a result, short-circuiting can be prevented in a normal use temperature range and battery yield can be improved dramatically. In the present invention, even if filler grains have a small primary average grain size, when placed inside the separator, they allow for a desired control of clearances between themselves and the pores in the porous structure or through pores. In this sense, it is possible to use any desired combination of filler grains made of multiple materials or having different primary average grain sizes. Various methods are available for placing filler grains in the porous base and/or resin structure. They include: the method to form a resin structure using a coating material containing filler grains; the method to allow filler grains to be retained on/inside the surface and through pores of the microporous resin film; the method to add filler grains to the material fibers when making the non-woven fabric; and the method to soak the non-woven fabric in a resin solution that contains filler grains and a resin for bonding the grains with the non-woven fabric, thereby pre-fixing the filler grains to the non-woven fabric.

The separator proposed by the present invention should desirably have a porous resin structure, as explained above. In this case, the porous resin structure should desirably have a series of pores linked together to connect one side of the separator to the other side. However, it is also desirable that pinhole-type through pores be not present in the direction effectively vertical to the separator surface. Here, a “through pore” refers to a section that is exposed, without being covered by any of the separator components, and shows the other side of the separator when the separator is viewed from the opposite side effectively vertically. A separator having these through pores easily cause short-circuiting and may significantly reduce charge/discharge performance.

In the present invention, the separator film thickness is not specified. However, a desirable film thickness is 50 μm or less, because it enables the size of the electronic component to be reduced. However, separators thinner than 5 μm are not desirable, because their strength will drop substantially.

In the present invention, the aforementioned separator may be formed on an active electrode comprising a laminated collector and active layer to form an electrode-integrated electronic component separator. The electrode-integrated electronic component separator proposed by the present invention has positive and negative electrodes, each comprising a laminated collector and active layer. The collector can be made of any material as long as it is electrochemically stable and conductive. Among others, aluminum is used favorably for the positive electrode, while copper is used favorably for the negative electrode. In general, a complex oxide of lithium and cobalt is used as the active material comprising the active layer in the positive electrode. In addition, a complex oxide of lithium and nickel, and another containing manganese or other transition metal, are also favorable. The active material composing the active layer in the negative electrode may be any material as long as it is electrochemically stable and capable of occluding and releasing lithium ions, such as carbon black and graphite. Grains of any of these active materials are mixed into a binder and laminated/affixed onto the collector to form an active layer. Examples of the aforementioned binder include polyvinylidene fluoride resin or its copolymer resin, and polyacrylonitrile resin. However, other materials can also be used as long as they are insoluble in an electrolyte solution and electrochemically stable.

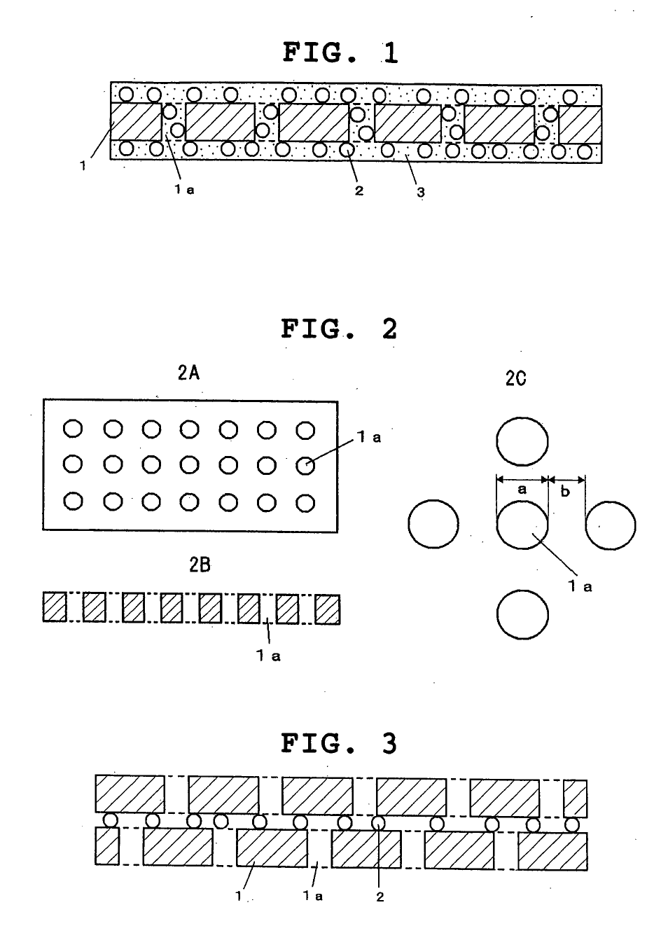

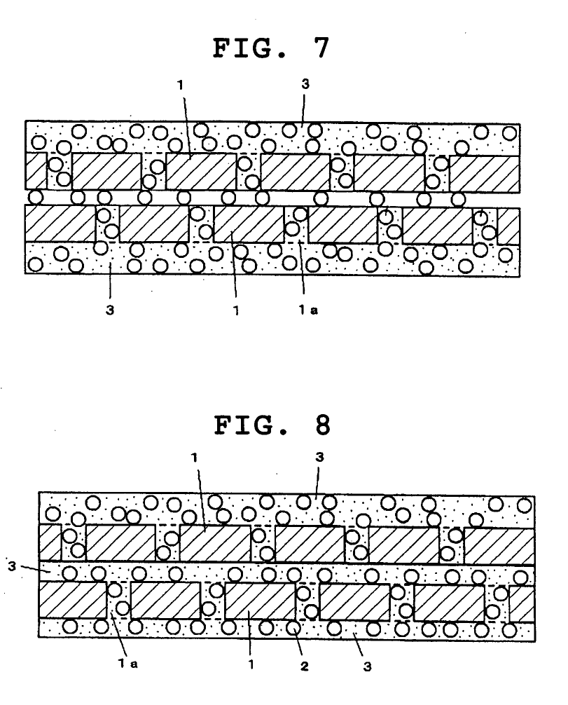

Next, examples of a separator that uses a microporous resin film as its porous base are explained using drawings. FIG. 1 is a schematic section drawing of a microporous resin film with a porous film comprising a porous structure formed on both top and bottom. FIG. 6 is a schematic section drawing of a microporous resin film with a porous film comprising a porous structure formed only on one side (refer to Example 14 presented later). In these figures, 1, 1a, 2 and 3 represent microporous resin film, through pore, filler grain and porous structure, respectively.

In the electronic component separator proposed by the present invention, the aforementioned microporous resin film may be laminated in multiple layers. FIG. 3 is a schematic section drawing showing an example of a porous base that comprises two microporous resin films on which filler grains are attached. In the present invention, two or more microporous resin films can be arranged in such a way that their through pores do not connect directly in the vertical direction, as shown in FIG. 3. This configuration prevents dendrite growth during overcharging or charge/discharge cycles without fail, at least in the solid resin part of the aforementioned microporous resin films. This also prevents short-circuiting in an early stage of charge/discharge cycles that may otherwise occur due to dendrite generation in lithium ion secondary batteries, lithium polymer secondary batteries and other electronic components using lithium metal. Also in the present invention, two or more microporous resin films to be stacked may have the same structure and through-pore phase, with the through pores in each film arranged in such a way that they connect in the direction vertical to the separator surface. Furthermore in the present invention, multiple porous bases of different structures can be stacked. Also, a separator contacting the positive electrode can be designed separately from a separator contacting the negative electrode and the two separators can be stacked together. If multiple microporous resin films are used, providing certain measures, such as forming an ion channel by placing filler grains between the multiple microporous resin films, as shown in FIG. 3, will have a desirable effect on battery performance. By providing these filler grains as those made of polyolefin resins such as polyethylene, a shutdown effect can also be achieved.

Next, the method for producing the electronic component separator proposed by the present invention is explained. The first mode of the method for producing the electronic component separator proposed by the present invention is as follows: place on top of a retainer material made of a resin film, etc., a porous base made of a substance having a melting point of 180° C. or above and on which filler grains are retained; coat the porous base with a coating material that contains a resin for forming a porous resin structure; dry the coating layer to form a porous resin structure on the surface of and/or inside the porous base; and then remove the retainer material.

The second mode of the production method is as follows: coat a retainer material made of a resin film, etc., with a coating material that contains a resin for forming a porous resin structure to form a coating layer; place on the coating layer a porous base made of a substance having a melting point of 180° C. or above and on which filler grains are retained; dry the coating layer to form a porous structure on the surface of and/or inside the porous base; and then remove the retainer material.

The third mode of the production method is as follows: coat a porous base made of a substance having a melting point of 180° C. or above with a coating material that contains a resin for forming a porous resin structure; and then dry the coating layer to form a porous structure on the surface of and/or inside the porous base.

Also, the electrode-integrated separator proposed by the present invention may be produced by way of forming the aforementioned separator on top of an active electrode layer comprising a collector and an active layer. To be specific, this electrode-integrated separator can be produced through: a process of placing on an active electrode layer comprising a collector and an active layer, a porous base made of a substance having a melting point of 180° C. or above and on which filler grains are retained; a process of applying on the porous base a coating solution that contains a binder resin and its good solvent and poor solvent; and a process of drying the formed coating layer and removing the solvents to form a porous structure on the surface of and/or inside the porous base.

Each of the aforementioned methods proposed by the present invention is capable of forming the aforementioned resin structure only by means of coating. These methods are also capable of forming a porous resin structure virtually with a single pass through a drying process, without using solvent substitution or extraction using other solvent or any other separate means in the process of removing the solvents from the coated surface.

In the present invention, a porous resin structure can be formed using a coating material that contains at least one type of solvent virtually capable of dissolving the resin that composes the resin structure (good solvent) and at least one type of solvent virtually incapable of dissolving the aforementioned resin (poor solvent). The technology to produce a porous film only through a drying process by using good and poor solvents has been known for many years. However, the inventors of the present invention found that the quick drying properties of both solvents and air-volume setting in the drying process would change film performance considerably and also have significant impact on production efficiency. In other words, heating and blow-drying have significant impact on separator performance. To be specific, the inventors have found that the drying speed determined by the boiling points and vapor pressures of both solvents, drying timings of both solvents, and air volume, are very important. In the present invention, a porous structure can be formed efficiently by properly controlling the drying conditions to the levels specified later through the use of good and poor solvents. Since it is important to reduce the viscosity of the coating material to a certain level to facilitate the handling of the coating material, it is desirable that an auxiliary good solvent having a relatively low viscosity be used together with a main good solvent to reduce the viscosity of the coating material. This auxiliary good solvent should be selected by considering its viscosity as just mentioned, as well as its drying balance with respect to the poor solvent and azeotropy resulting from mixing with other solvents. In the present invention, not only one but also multiple types of auxiliary good solvents may be used. As long as they are not poor solvents virtually incapable of dissolving the resin, any solvents can be selected and used as auxiliary good solvents based on the selection guidelines mentioned above.

Various solvents can be used as good and poor solvents, but combinations that lead to azeotropy or large differences in drying temperature or vapor pressure are not desirable, because they increase the occurrence frequency of large pinholes and reduce production efficiency. The difference in boiling point between the good and poor solvents should be preferably within 50° C., or more preferably within 30° C., from the viewpoint of production efficiency. If the difference exceeds 50° C., the production process speed cannot be increased and a large amount of dying energy will be required. If multiple drying steps are set when good/poor solvents with a boiling-point difference of over 50° C. are used, the conditions cannot be switched instantaneously toward the process direction, which is not suitable in mass production.

To obtain a coating material using solvents of high moisture absorption, it is necessary to prevent mixing in of water as much as possible. In the present invention, the water content should be kept to 0.7 percent by weight or less, or more preferably to 0.5 percent by weight or less, as measured by the Karl Fischer method. If the water content exceeds 0.7 percent by weight, gelatinization will progress quickly and the storage period of the coating material may shorten considerably or the film production property may be negatively affected.

When creating a separator proposed by the present invention that contains filler grains made only of polyolefin resins such as polyethylene, it is desirable to adjust the temperature condition to one that prevents melting of filler grains as much as possible. However, many solvents that dissolve polyvinylidene fluoride have a high boiling point, so in practice the heating temperature must be set to a range of 70 to 180° C. To address this problem, the volume of drying air should be increased to quicken the drying process or the process speed should also be raised to allow the drying process to end over the shortest possible time. If the heating temperature is 70° C. or below, a poor drying efficiency will keep production efficiency low. If the heating temperature exceeds 180° C., on the other hand, the filler grains and resin structure may melt and negatively affect the shutdown function to be added.

In general, it is desirable in the production of a porous resin structure to set multiple drying steps to dry the good solvent first, followed by the poor solvent. From the viewpoint of separator film performance, however, both solvents need not be dried separately as long as they do not cause azeotropy. Instead, ideally the drying conditions should be determined in such a way that the porosity and pore diameter of the porous structure can be controlled at appropriate levels. In the present invention, the negative effects the separator can have on battery performance can be minimized, while production efficiency can be improved, by selecting an appropriate solvent combination along with appropriate drying temperature and air volume, etc., as explained above. In the present invention, an optimal porous film can be formed easily on the separator only with a single drying process after coating, without having to provide a process of removing the poor solvent or solvent residues using other solvent, etc., as explained above. Since this results in very high production efficiency, a large quantity of quality separators can be provided at low cost.

In the present invention, coating can be applied using the dip coating method, spray coating method, roll coating method, doctor blade method, gravure coating method or screen printing method by way of coating, casting, etc. However, it is desirable to use in the coating process a retainer material on which to place the porous base. Examples of this retainer material include resin films made of polypropylene or polytetrafluoroethylene, and glass plate. The retainer material may be given a surface treatment for the purpose of separation or simple bonding. Among others, resin films offering flexibility are desirable as the retainer material, because they also function as a surface protection film on the electronic component separator. Use of a flexible resin film as the retainer material is also desirable in that the electronic component separator will remain on the resin film after the drying process so the laminated film/separator can be rolled together easily for storage and transfer.

In the present invention, any of the three modes of production explained earlier can be used suitably. If a resin film is used as the retainer material, however, the second mode is preferred over the first mode in certain conditions such as when the porous base has a high porosity. To be specific, the first mode applies a coating material after a porous base is placed on top of a resin film. Therefore, air is trapped easily in the porous base, such as in the gaps between fibers, and this can lead to coating defects. Nonetheless, compared with the second mode in which a porous base is placed on a wet coated surface via wet lamination after a coating material is applied on a resin film, the first mode allows the porous base to be rolled together with the resin film beforehand, which eliminates the need for a mechanism that separately unrolls the porous base as required in the second mode. As a result, the first mode offers higher production efficiency. For this reason, the first mode is suitable when the porous base has a relatively low porosity and poses no problem in its film production property. An appropriate porosity of the porous base should be determined by giving priority to the battery design, after which an appropriate joining method of the porous base should be selected based on the design requirements. In the second mode, a uniform separator free from coating defects can be produced regardless of the level of porosity of the porous base. In the present invention, however, a uniform separator can be produced using either method, by selecting an appropriate production condition based on the various properties of the porous base, a representative of which is the porosity mentioned earlier.

In the first and second modes of production as proposed by the present invention, peel strength of the retainer material must be considered. If a resin film is used as the retainer material, the peel strength of the resin film with respect to the porous structure should preferably be in a range of 0.1 to 75 (g/20 mm), or more preferably in a range of 0.1 to 40 (g/20 mm). Peel strength is measured by separating the edge of a porous resin structure formed on a resin film, affixing the separated edge and the edge of the resin film on the same side to the upper and lower chucks of a tensilon, and then obtaining a tensile strength as an average of five measured tensile loads divided by the width of the test piece.

Especially with the second mode that uses wet lamination, a coating material is applied on a resin film before a porous base is joined, as explained earlier. If the resin film has a relatively good separation property as indicated by a peel strength of less than 0.1 g/20 mm, the wet coated surface immediately after coating will not stabilize when the viscosity of the coating material is low, and the coating weight per unit area will fluctuate during the period immediately after coating until wet lamination. This, in turn, will result in a fluctuating weight per unit area of the porous structure in the surface direction of the separator. This phenomenon is essentially due to the surface tension of the resin film. Use of the aforementioned resin film is also undesirable because the separator may separate from the resin film during the drying process. On the other hand, a resin film offering high adhesion as indicated by a peel strength exceeding 75 g/20 mm is not desirable, either, because the separator cannot be separated efficiently from the resin film, although such film will not cause the above weight fluctuation.

Meanwhile, the first mode of production under the present invention as mentioned above, in which a porous base is placed on top of a resin film and then a coating material is applied on the porous base, allows the coating material to be applied directly on the porous base and therefore keeps the fluidity of the coating material low as the grains of the coating material twine closely around the fibers of the porous base. Therefore, even a resin film with a peel strength of less than 0.1 g/20 mm does not cause the aforementioned weight fluctuation problem in the wet lamination process. However, the separator may still separate from the resin film during the drying process, so a peel strength of less than 0.1 g/20 mm is still undesirable. On the other hand, a resin film with a peel strength exceeding 75 g/20 mm is not desirable, because, as in the case of wet lamination, the separator cannot be separated efficiently from the resin film.

Another benefit of using a resin film with its peel strength in the aforementioned range is that the separator pore diameter can be controlled by means of its peel strength. Specifically, when designing the peel strength of the resin film in a low range near 0.1 g/20 mm, the diameters of pores on the side of the separator contacting the resin film will become larger than the diameters of pores on the side of the separator that becomes its surface coating layer. If the peel strength is designed in a high range near 75 g/20 mm, on the other hand, the diameters of pores on the side of the separator contacting the resin film surface will become smaller than the diameters of pores on the side of the separator that becomes its surface coating layer. This applies to both of the joining methods presented by the first and second modes of production mentioned earlier.

If the peel strength of the resin film is less than 0.1 g/20 mm, the pores on the side of the separator contacting the resin film may be blocked. If the peel strength of the resin film exceeds 75 g/20 mm, the pores on the side of the separator that becomes its surface coating layer may become blocked easily. The causes of these phenomena are not exactly clear, but one probable factor is the level of surface tension, because a similar asymmetry in the pore diameters on top and bottom of the separator occurs when porous base materials of different surface tensions are used. Accordingly, in the present invention it becomes possible to use the surface characteristics of the resin film to control the symmetry in pore diameters on top and bottom of the porous structure that is joined with the porous base, even when a certain material must be used as the porous base to meet the requirements of the battery design. In other words, while conventional separators have sometimes failed to control the aforementioned symmetry in pore diameters on top and bottom depending on the material of the porous base, the present invention allows for the pore diameter symmetry to be controlled by setting an appropriate peel strength for the resin film, which is not a component of the separator.

### EFFECT OF THE INVENTION

The electronic component separator proposed by the present invention maintains various practical characteristics at desirable levels, undergoes minimal heat shrinkage in the event of overheating, and offers high reliability and excellent workability. Therefore, the electronic component separator proposed by the present invention exhibits excellent short-circuiting resistance, low impedance and high heat resistance when used in electronic components such as lithium ion secondary batteries, polymer lithium secondary batteries, lithium metal batteries, aluminum electrolytic capacitors and electric double-layer capacitors, and can therefore be used favorably in the designs of these electronic components. In particular, the porous base of the electronic component separator proposed by the present invention offers excellent dimensional stability under heat and is thus capable of reliably adding dimensional stability under heat to the separator. This feature is particularly suitable for use in large lithium batteries and electric double-layer capacitors requiring higher heat resistance.

### BEST MODE FOR CARRYING OUT THE INVENTION

Specific examples in which the electronic component separator proposed by the present invention can be applied suitably are those using a porous resin structure made of a vinylidene fluoride resin such as polyvinylidene fluoride or vinylidene fluoride copolymer. These separators can be produced in the manner explained below.

First, a vinylidene fluoride resin is dispersed in a solvent. The solvent must be capable of dissolving the vinylidene fluoride resin (good solvent). Examples of this good solvent include N,N-dimethyl acetamide, N,N-dimethyl formamide, 1-methyl-2-pyrrolidone and N,N-dimethyl sulfoxide. Dispersion and dissolution can be performed using commercially available mixers. Vinylidene fluoride resins dissolve easily in N,N-dimethyl acetamide, N,N-dimethyl formamide, 1-methyl-2-pyrrolidone and N,N-dimethyl sulfoxide in room temperature, so there is no need to heat the solvent containing the resin. Thereafter, a solvent incapable of dissolving the vinylidene fluoride resin (poor solvent) is added. The poor solvent should desirably have a higher boiling point than the good solvent. Examples of this poor solvent include dibutyl phthalate, ethylene glycol, diethylene glycol and glycerin. The concentration of vinylidene fluoride resin must be adjusted to an appropriate level by considering the target characteristics of the resulting separator.

In a coating material in which a vinylidene fluoride resin, poor solvent, etc., are dissolved, as obtained by the above operation, it is necessary to prevent mixing in of water as much as possible if the solvents used have high moisture absorption. In the present invention, the water content should be kept to 0.7 percent by weight or less, or more preferably to 0.5 percent by weight or less, as measured by the Karl Fischer method. If the water content exceeds 0.7 percent by weight, gelatinization will progress quickly and the storage period of the coating material may shorten considerably or the film production property may be negatively affected.

Next, the coating material obtained above is applied on the aforementioned fibrous base made of a non-woven fabric or netlike substance or on the aforementioned microporous resin film, in which the aforementioned filler grains have been added in advance. One way of achieving this is through the method of placing the fibrous base on top of a retainer material, and then coating on the fibrous base the aforementioned coating material in which a vinylidene fluoride resin, poor solvent, etc., are dissolved. As the retainer material, a resin film made of polypropylene, polytetrafluoroethylene, etc., or a glass plate can be used. Among others, resin films offering flexibility are desirable as the retainer material, because they also function as a surface protection film on the electronic component separator. Use of a flexible resin film as the retainer material is also desirable in that the electronic component separator will remain on the resin film after the drying process so the laminated film/separator can be rolled together easily for storage and transfer.

As the method to apply the vinylidene fluoride resin on the fibrous base or microporous resin film, the aforementioned dip coating method, spray coating method, roll coating method, doctor blade method, gravure coating method or screen printing method can be used by way of coating, casting, etc. Consequently, the vinylidene fluoride resin enters the inside of the fibrous base or pores in the microporous resin film. Next, the solvents are evaporated through drying from the coating layer containing the vinylidene fluoride resin, as formed on the fibrous base or microporous resin film, in order to obtain the electronic component separator proposed by the present invention. In this case, polyvinylidene fluoride remains inside the fibrous base or pores in the microporous resin film, while film-like product comprising polyvinylidene fluoride is formed on one or both sides of the fibrous base or microporous resin film. The electronic component separator proposed by the present invention is used after being separated from the retainer material.

### EXAMPLES

Next, the present invention is explained by using examples. In the examples described below, the pore diameters on the sides of the separator directly contacting/not contacting the resin film were measured using the bubble point method, and the smaller of the two was taken as the pore diameter of the separator. The pore diameter distribution in the thickness direction was observed by an electron microscope. For your reference, the pore diameter of the porous resin structure was controlled by way of selecting appropriate conditions for coating material production, drying and pressing.

### Example 1

Vinylidene fluoride homopolymer with an average molecular weight of 300,000 was dissolved in 1-methyl-2-pyrrolidone, to which dibutyl phthalate was added to prepare a solution containing vinylidene fluoride homopolymer by 15 percent by weight. The water content of this solution as measured by the Karl Fischer method was 0.6%. Next, a non-woven fabric with a thickness of 10 μm, made of polyethylene terephthalate fibers made only of fibers with a melting point of 260° C. and on which 5 g/m² of PTFE grains with a primary average grain size of 0.25 μm and melting point of 320° C. were retained, was placed on the surface of a resin film made of polyethylene terephthalate, and then the aforementioned solution was applied on the non-woven fabric using the casting method. Next, the solvents in the solution that has penetrated into the non-woven fabric were evaporated by way of heating to produce a separator with a thickness of 22 μm, having a porous resin structure of vinylidene fluoride homopolymer formed between the fibers of the non-woven fabric. The peel strength of the aforementioned resin film with respect to the porous resin structure was 15 g/20 mm.

When the obtained electronic component separator was observed by an electron microscope, no defects such as pinholes were found. The pores in the aforementioned porous resin structure were made of a series of many pores linked together to connect one side of the non-woven fabric comprising the porous base to the other side of the fabric, and the diameters of individual pores were smaller than the thickness of the fibrous base. The distribution of pore diameters was consistent in the thickness direction of the separator, confirming a uniformity of the porous structure in the thickness direction. The pore diameter of the separator as measured by the bubble point method was 1.2 μm.

### Example 2

An electronic component separator was produced in the same manner as in Example 1, except that a non-woven fabric with a thickness of 15 μm, made only of vinylon fibers having a melting point of 205° C., was used as the porous base. When the obtained electronic component separator was observed by an electron microscope, no defects such as pinholes were found. The porous resin structure had a series of many pores linked together to connect one side of the porous base to the other side, and the diameters of individual pores were smaller than the thickness of the porous base. The distribution of pore diameters was consistent in the thickness direction of the separator, confirming a uniformity of the porous structure in the thickness direction. The pore diameter of the separator as measured by the bubble point method was 1.0 μm.

### Example 3

An electronic component separator was produced in the same manner as in Example 1, except that a microporous resin film with a thickness of 15 μm, made of polyethylene terephthalate with a melting point of 200° C. and having only through pores that are formed in the vertical direction in a manner virtually free from any shielding structure and connecting one side of the resin film to the other side, was used as the porous base. When the obtained electronic component separator was observed by an electron microscope, no defects such as pinholes were found. The porous resin structure had a series of many pores linked together to connect one side of the porous base to the other side, and the diameters of individual pores were smaller than the thickness of the microporous resin film. The distribution of pore diameters was consistent in the thickness direction of the separator, confirming a uniformity of the porous structure in the thickness direction. The pore diameter of the separator as measured by the bubble point method was 0.8 μm.

### Example 4

Polymethyl methacrylate with an average molecular weight of 500,000 was dissolved in acetone, to which dibutyl phthalate was added to prepare a solution containing polymethyl methacrylate by 12 percent by weight. The water content of this solution as measured by the Karl Fischer method was 0.5%. An electronic component separator comprising an integrated non-woven fabric and porous resin structure was produced in the same manner as in Example 1, except that the aforementioned solution was used. The thickness of the obtained electronic component separator was 20 μm. When the obtained electronic component separator was observed by an electron microscope, no defects such as pinholes were found. The porous resin structure had a series of many pores linked together to connect one side of the porous base to the other side, and the diameters of individual pores were smaller than the thickness of the non-woven fabric. The distribution of pore diameters was consistent in the thickness direction of the separator, confirming a uniformity of the porous structure in the thickness direction. The pore diameter of the separator as measured by the bubble point method was 1.2 μm.

### Example 5

An electronic component separator was produced in the same manner as in Example 4, except that tetrahydrofuran was used instead of acetone. The water content of this solution as measured by the Karl Fischer method was 0.6%. An electronic component separator comprising an integrated non-woven fabric and porous structure was obtained in the same manner as in Example 4, except that the aforementioned solution was used. The thickness of the obtained electronic component separator was 21 μm. When the obtained electronic component separator was observed by an electron microscope, no defects such as pinholes were found. The porous resin structure had a series of many pores linked together to connect one side of the porous base to the other side, and the diameters of individual pores were smaller than the thickness of the non-woven fabric. The distribution of pore diameters was consistent in the thickness direction of the separator, confirming a uniformity of the porous structure in the thickness direction. The pore diameter of the separator as measured by the bubble point method was 0.7 μm.

### Example 6

An electronic component separator was produced in the same manner as in Example 1, except that a resin film made of polyethylene terephthalate with a peel strength of 2 g/20 mm with respect to the porous resin structure was used. The thickness of the obtained electronic component separator was 20 μm. When the obtained electronic component separator was observed by an electron microscope, no defects such as pinholes were found. The aforementioned porous resin structure had a series of many pores linked together to connect one side of the porous base to the other side, and the diameters of pores on the side of the separator contacting the retainer material were large, while those of pores on the side not contacting the reins film were small. The pore diameter of the separator as measured by the bubble point method was 1.2 μm.

### Example 7

An electronic component separator was produced in the same manner as in Example 1, except that a resin film made of polyethylene terephthalate with a peel strength of 55 g/20 mm with respect to the porous resin structure was used. The thickness of the obtained electronic component separator was 21 μm. When the obtained electronic component separator was observed by an electron microscope, no defects such as pinholes were found. The porous resin structure had a series of many pores linked together to connect one side of the porous base to the other side, and the diameters of individual pores were smaller than the thickness of the porous base. The diameters of pores on the side of the separator contacting the retainer material were small, while those of pores on the side not contacting the reins film were large. The pore diameter of the separator as measured by the bubble point method was 1.3 μm.

### Example 8

An electronic component separator was produced in the same manner as in Example 1, except that the solution was applied on the resin film surface first, and while the coated surface was still wet the porous base was integrated with the porous resin structure via wet lamination. The thickness of the obtained electronic component separator was 23 μm. When the obtained electronic component separator was observed by an electron microscope, no defects such as pinholes were found. The porous resin structure had a series of many pores linked together to connect one side of the porous base to the other side, and the diameters of individual pores were smaller than the thickness of the porous base. The distribution of pore diameters was consistent in the thickness direction of the separator, confirming a uniformity of the porous structure in the thickness direction. The pore diameter of the separator as measured by the bubble point method was 1.0 μm.

### Example 9

An electronic component separator was produced in the same manner as in Example 1, except that 20 g/m² of filler grains with a primary average grain size of 2 μm, comprising bridged PMMA with a melting point of 190° C., retained on a non-woven fabric, were used as the porous base. The thickness of the obtained electronic component separator was 24 μm. When the obtained electronic component separator was observed by an electron microscope, no defects such as pinholes were found. The formed porous resin structure had a series of many pores linked together to connect one side of the porous base to the other side, and the diameters of individual pores were smaller than the thickness of the porous base. The distribution of pore diameters was consistent in the thickness direction of the separator, confirming a uniformity of the porous structure in the thickness direction. The pore diameter of the separator as measured by the bubble point method was 0.8 μm.

### Example 10

An electronic component separator was produced in the same manner as in Example 1, except that 30 g/m² of silica filler grains with a primary average grain size of 50 nm retained on a non-woven fabric were used as the porous base. The thickness of the obtained electronic component separator was 20 μm. When the obtained electronic component separator was observed by an electron microscope, no defects such as pinholes were found. The porous resin structure had a series of many pores linked together to connect one side of the porous base to the other side, and the diameters of individual pores were smaller than the thickness of the porous base. The distribution of pore diameters was consistent in the thickness direction of the separator, confirming a uniformity of the porous structure in the thickness direction. The pore diameter of the separator as measured by the bubble point method was 0.5 μm.

### Comparative Example 1

A non-woven fabric with a thickness of 25 μm, made of polyethylene terephthalate fibers with a melting point of 185° C., was used as a comparative separator.

### Comparative Example 2

A stretched porous polyethylene film with a thickness of 20 μm was used as a comparative separator.

### Comparative Example 3

A comparative separator was produced in the same manner as in Example 1, except that a non-woven fabric with a thickness of 10 μm, made of a mixture of polyethylene terephthalate fibers with a melting point of 260° C. and polyethylene terephthalate fibers with a melting point of 130° C., and on which 80 g/m² of polyethylene grains with a melting point of 120° C. were retained instead of the PTFE grains with a melting point of 320° C., was used.

The characteristics of the separators obtained in the aforementioned examples and comparative examples, when used in a lithium ion secondary battery, were evaluated as follows.

[Dimensional Stability Under Heat]

The separator obtained in each example or comparative example was cut to a square of 5×5 cm² in size and then sandwiched between two glass plates, each of 10×10 cm² in size and 5 mm in thickness. Then, the assembly was placed horizontally in a stationery manner on an aluminum vat, and left overnight in a dryer controlled at 150° C. to examine the change in area due to heat.

The change in area was evaluated as the rate of change in area, calculated by (Area after test/Area before test: 25 cm²)×100%. The results are shown in Table 1.

TABLE 1

| | Rate of change in area % |
|---|---|
| Example 1 | 99.2 |
| Example 2 | 98.3 |
| Example 3 | 99.1 |
| Example 4 | 99.4 |
| Example 5 | 98.5 |
| Example 6 | 99.8 |
| Example 7 | 98.1 |
| Example 8 | 98.8 |
| Example 9 | 98.7 |
| Example 10 | 99.0 |
| Comparative Example 1 | 87.1 |
| Comparative Example 2 | 48.1 |
| Comparative Example 3 | 59.2 |

As evident from the above results, all of the separators conforming to the present invention, as obtained in Examples, exhibited good dimensional stability under heat. On the contrary, all separators obtained in Comparative Examples had lower dimensional stability under heat than the separators obtained in Examples. The separator obtained in Comparative Example 1 showed fairly good dimensional stability under heat, but the result was still lower than the levels exhibited by the separators in Examples, probably because of absence of porous resin structure.

[Alternating-Current Impedance]

A coin-shaped cell was produced from each of the aforementioned separators to measure the alternating-current impedance of the cell. The results are shown in Table 2.

TABLE 2

| | Ion conductance σ (S/cm) |
|---|---|
| Example 1 | 4.48E−04 |
| Example 2 | 4.56E−04 |
| Example 3 | 4.78E−04 |
| Example 4 | 4.32E−04 |
| Example 5 | 4.52E−04 |
| Example 6 | 4.59E−04 |
| Example 7 | 4.46E−04 |
| Example 8 | 5.72E−04 |
| Example 9 | 4.40E−04 |
| Example 10 | 4.99E−04 |
| Comparative Example 1 | 4.10E−04 |
| Comparative Example 2 | 2.10E−04 |
| Comparative Example 3 | 3.41E−04 |

As evident from the above results, all of the separators conforming to the present invention, as obtained in Examples, exhibited excellent ion conductance.

[Short-Circuiting Resistance]

Next, a short-circuiting resistance test was conducted. Each separator (5×5 cm²) was sandwiched between two stainless steel plates (3×3 cm²). In a condition where an electric potential difference of 80 V exists between the stainless steel electrodes, pressures were applied to both electrodes in the opposing directions to examine the pressure level at which short-circuiting occurred. The results are shown in Table 3.

TABLE 3

| | Pressure at which short- |
|---|---|
| | circuiting occurred (kg/cm²) |
| Example 1 | 248 |
| Example 2 | 269 |
| Example 3 | 300 or more |
| Example 4 | 230 |
| Example 5 | 226 |
| Example 6 | 256 |
| Example 7 | 247 |
| Example 8 | 255 |
| Example 9 | 296 |
| Example 10 | 300 or more |
| Comparative Example 1 | 51 |
| Comparative Example 2 | 187 |
| Comparative Example 3 | 197 |

As evident from the above results, the separators conforming to the present invention, as obtained in Examples, did not cause short-circuiting easily and therefore exhibited desirable electrical insulation performance higher than the levels achieved by conventional separators. On the other hand, the comparative separator made only of a non-woven fabric, which exhibited a relatively good result in the ion conductance test, showed a very poor result in terms of electrical insulation performance.

Based on the results of the above three tests, the electrical component separators conforming to the present invention satisfied all characteristic requirements, while the comparative separators failed to satisfy all characteristic requirements. In other words, the comparative separators exhibited insufficient performance for use in electrochemical devices that must maintain stable performance in a relatively high temperature range.

### Example 11

Vinylidene fluoride homopolymer with an average molecular weight of 300,000 was dissolved in 1-methyl-2-pyrrolidone and dimethyl acetamide (good solvents), to which dibutyl phthalate (poor solvent) was added to prepare a coating solution containing vinylidene fluoride homopolymer by 10 percent by weight. The water content of this coating solution as measured by the Karl Fischer method was 0.6 percent by weight. Next, a microporous polyethylene terephthalate film of 8 μm in thickness, having through pore diameter a of 7 μm and minimum distance between adjacent through pores b of 10 μm and on which 1 g/m² of polyethylene grains with a grain size of 5 μm and softening point of 113° C. were retained, was placed on a resin film made of polyethylene terephthalate, and then the aforementioned coating solution was applied on the microporous film using the casting method. Next, the solvents in the coating solution were evaporated by way of heating, after which the resin film was separated and removed to obtain an electronic component separator with a thickness of 20 μm, with a porous layer comprising a porous vinylidene fluoride homopolymer structure formed on top and bottom of the separator. A schematic drawing showing the section structure of this separator is given in FIG. 1. The peel strength of the resin film with respect to the porous structure was 15 g/20 mm.

When the obtained electronic component separator was observed by an electron microscope, both sides of the separator were connected via many pores in the porous structure as well as pores comprising through pores. The diameters of individual pores were smaller than the thickness of the microporous film. The distribution of pore diameters in the porous structure was consistent in the thickness direction of the separator, conforming a uniformity of the porous structure in the thickness direction. The average diameter of these pores as measured by the bubble point method was 6.0 μm, from which the primary average grain size of polyethylene grains was calculated as 83.3% of the pore diameter of the porous structure.

### Example 12

Vinylidene fluoride homopolymer with an average molecular weight of 300,000 was dissolved in 1-methyl-2-pyrrolidone and dimethyl acetamide (good solvents), to which dibutyl phthalate (poor solvent) was added to prepare a coating solution containing vinylidene fluoride homopolymer by 5 percent by weight. The water content of this coating solution as measured by the Karl Fischer method was 0.65 percent by weight. Next, a microporous polyethylene terephthalate film of 6 μm in thickness, having through pore diameter a of 3 μm and minimum distance between adjacent through pores b of 7 μm and on which 15 g/m₂ of polyethylene grains with a grain size of 1 μm and softening point of 113° C. and polyethylene grains with a grain size of 1 μm and softening point of 132° C. were retained, was placed on a resin film made of polyethylene terephthalate, and then the aforementioned coating solution was applied on the microporous film using the casting method. Next, the solvents in the coating solution were evaporated by way of heating, after which the resin film was separated and removed to obtain a porous film comprising a porous vinylidene fluoride homopolymer structure formed on top and bottom of the microporous film. This porous film was then pressed to obtain an electronic component separator with a thickness of 10 μm. A schematic drawing showing the section structure of this separator is also given in FIG. 1. The peel strength of the resin film with respect to the porous structure was 0.5 g/20 mm.

When the obtained electronic component separator was observed by an electron microscope, both sides of the separator were connected via many pores in the porous structure as well as pores comprising through pores. The diameters of individual pores were smaller than the thickness of the microporous film. The distribution of pore diameters in the porous structure was nearly consistent in the thickness direction of the separator, but the diameters of pores on the side contacting the resin film provided as the retainer material were slightly larger than those of pores on the side not contacting the resin film. The average diameter of these pores as measured by the bubble point method was 2.0 μm, from which the primary average grain size of polyethylene grains was calculated as 50% of the pore diameter of the porous structure.

### Example 13

Vinylidene fluoride homopolymer with an average molecular weight of 500,000 was dissolved in 1-methyl-2-pyrrolidone and dimethyl acetamide (good solvents), to which dibutyl phthalate (poor solvent) was added to prepare a coating solution containing vinylidene fluoride homopolymer by 5 percent by weight. The water content of this coating solution as measured by the Karl Fischer method was 0.4 percent by weight. Next, a microporous polyethylene terephthalate film of 10 μm in thickness, having through pore diameter a of 5 μm and minimum distance between adjacent through pores b of 6 μm and on which 30 g/m² of polyethylene grains with a grain size of 3 μm and softening point of 113° C. and polypropylene grains with a grain size of 3 μm and softening point of 148° C. were retained, was placed on a resin film made of polyethylene terephthalate, and then the aforementioned coating solution was applied on the microporous film using the casting method. Next, the solvents in the coating solution were evaporated by way of heating, after which the resin film was separated and removed to obtain a porous film comprising a porous vinylidene fluoride homopolymer structure formed on top and bottom of the microporous film. This porous film was then pressed to obtain an electronic component separator with a thickness of 8 μm. A schematic drawing showing the section structure of this separator is also given in FIG. 1. The peel strength of the resin film with respect to the porous structure was 65 g/20 mm.

When the obtained electronic component separator was observed by an electron microscope, both sides of the separator were connected via many pores in the porous structure as well as pores comprising through pores. The diameters of individual pores were smaller than the thickness of the microporous film. The distribution of pore diameters in the porous structure was consistent, confirming a uniformity of the porous structure in the thickness direction. The average pore diameter of these pores as measured by the bubble point method was 3.6 μm, from which the primary average size of polyethylene grains was calculated as 83.3% of the pore diameter of the porous structure.

### Example 14

In Example 12, both the top and bottom of the microporous film were rubbed with a urethane rubber blade while the surface was still wet after coating/joining to remove the coating solution and polyethylene grains existent on both sides. Thus treated microporous film was placed on the same resin film used in Example 11, and then dried under the same condition as in Example 11 to obtain an electronic component separator with a thickness of 6 μm. A schematic drawing showing the section structure of this separator is given in FIG. 5.

When the obtained electronic component separator was observed by an electron microscope, both sides of the separator were connected via many pores in the porous structure as well as pores comprising through pores. The diameters of individual pores were smaller than the thickness of the microporous film. The distribution of through pore diameters was consistent in the thickness direction of the separator, confirming a uniformity of the porous structure in the thickness direction. The average pore diameter of the aforementioned separator as measured by the bubble point method (in this case, the diameter of pores formed as through pores) was 5.5 μm, from which the primary average size of polyethylene grains was calculated as 18% of the pore diameter of the separator.

### Example 15

Vinylidene fluoride homopolymer with an average molecular weight of 200,000 was dissolved in 1-methyl-2-pyrrolidone and dimethyl acetamide (good solvents), to which dibutyl phthalate (poor solvent) was added to prepare a coating solution containing vinylidene fluoride homopolymer by 8 percent by weight. The water content of this coating solution as measured by the Karl Fischer method was 0.43 percent by weight. Next, a microporous polyethylene terephthalate film of 20 μm in thickness, having through pore diameter a of 45 μm and minimum distance between adjacent through pores b of 90 μm and on which 5/m² of polyethylene grains with a grain size of 8 μm and softening point of 132° C. and polypropylene grains with a grain size of 4 μm and softening point of 148° C. were retained, was placed on a resin film made of polyethylene terephthalate, and then the aforementioned coating solution was applied on the microporous film using the casting method. Next, the solvents in the coating solution were evaporated by way of heating, after which the resin film was separated and removed to obtain a porous film comprising a porous vinylidene fluoride homopolymer structure formed on top and bottom of the microporous film, with a similar porous structure also formed inside the through pores. This porous film was then pressed to obtain an electronic component separator with a thickness of 27 μm. A schematic drawing showing the section structure of this separator is also given in FIG. 1. The peel strength of the resin film with respect to the porous structure was 16 g/20 mm.

When the obtained electronic component separator was observed by an electron microscope, both sides of the separator were connected via many pores in the porous structure as well as pores comprising through pores, and the diameters of individual pores were smaller than the thickness of the microporous film. The distribution of pore diameters in the porous structure was consistent in the thickness direction of the separator, confirming a uniformity of the porous structure in the thickness direction. The average pore diameter of the porous structure as measured by the bubble point method was 10.5 μm, from which the primary average sizes of polyethylene grains and polypropylene grains were calculated as 76.2% and 38.1%, respectively, of the pore diameter of the separator.

### Example 16

Vinylidene fluoride homopolymer with an average molecular weight of 200,000 was dissolved in 1-methyl-2-pyrrolidone and dimethyl acetamide (good solvents), to which dibutyl phthalate (poor solvent) was added to prepare a coating solution containing vinylidene fluoride homopolymer by 8 percent by weight. The water content of this coating solution as measured by the Karl Fischer method was 0.45 percent by weight. Next, a microporous polyethylene terephthalate film of 9 μm in thickness, having through pore diameter a of 0.3 μm and minimum distance between adjacent through pores b of 5 μm and on which 3 g/m² of polyethylene grains with a grain size of 0.1 μm and softening point of 132° C. and polypropylene grains with a grain size of 0.2 μm and softening point of 148° C. were retained, was placed on a resin film made of polyethylene terephthalate, and then the aforementioned coating solution was applied on the microporous film using the casting method. Next, the solvents in the coating solution were evaporated by way of heating, after which the resin film was separated and removed to obtain a porous film comprising a porous vinylidene fluoride homopolymer structure formed on top and bottom of the microporous film. This porous film was then pressed to obtain an electronic component separator with a thickness of 16 μm. A schematic drawing showing the section structure of this separator is also given in FIG. 1. The peel strength of the resin film with respect to the porous structure was 17 g/20 mm.

When the obtained electronic component separator was observed by an electron microscope, both sides of the separator were connected via many pores in the porous structure as well as pores comprising through pores, and the diameters of individual pores were smaller than the thickness of the microporous film. The distribution of pore diameters in the porous structure was consistent in the thickness direction of the separator, confirming a uniformity of the porous structure in the thickness direction. The average diameter of these pores as measured by the bubble point method was 2.4 μm, from which the primary average sizes of polyethylene grains and polypropylene grains were calculated as 33.3% and 66.7%, respectively, of the through pores in the microporous film that were smaller than the pores in the separator.

### Example 17

Vinylidene fluoride homopolymer with an average molecular weight of 300,000 was dissolved in 1-methyl-2-pyrrolidone and dimethyl acetamide (good solvents), to which dibutyl phthalate (poor solvent) was added to prepare a coating solution containing vinylidene fluoride homopolymer by 5 percent by weight. The water content of this coating solution as measured by the Karl Fischer method was 0.50 percent by weight. Next, a microporous polyethylene terephthalate film of 28 μm in thickness, having through pore diameter a of 5 μm and minimum distance between adjacent through pores b of 20 μm and on which 3 g/m² of polyethylene grains with a grain size of 3 μm and softening point of 113° C. and polypropylene grains with a grain size of 3 μm and softening point of 148° C. were retained, was placed on a resin film made of polyethylene terephthalate, and then the aforementioned coating solution was applied on the microporous film using the casting method. Next, the solvents in the coating solution were evaporated by way of heating, after which the resin film was separated and removed to obtain an electronic component separator with a thickness of 50 μm, comprising a porous film made of a porous vinylidene fluoride homopolymer structure formed on top and bottom of the microporous film. A schematic drawing showing the section structure of this separator is also given in FIG. 1. The peel strength of the resin film with respect to the porous structure was 15 g/20 mm.

When the obtained electronic component separator was observed by an electron microscope, both sides of the separator were connected via many pores in the porous structure as well as pores comprising through pores, and the diameters of individual pores were smaller than the thickness of the microporous film. The distribution of pore diameters in the porous structure was consistent in the thickness direction of the separator, confirming a uniformity of the porous structure in the thickness direction. The average pore diameter of this separator as measured by the bubble point method was 4.6 μm, from which the primary average sizes of polyethylene grains and polypropylene grains were calculated as both 65.2% of the pores.

### Example 18

One hundred weight parts by weight of the coating solution obtained in Example 11 were mixed with 30 parts by weight of identical polyethylene grains comprising the filler grains used in Example 11 to prepare a coating solution. A microporous polyethylene terephthalate film of 8 μm in thickness, having through pore diameter a of 7 μm and minimum distance between adjacent through pores b of 10 μm, was placed on a resin film made of polyethylene terephthalate, and then the aforementioned coating solution was applied. The same processing used in Example 11 was performed subsequently to obtain a separator having a coating layer formed on both sides of the microporous film. Then, the coating layer was peeled only from one side to obtain an electronic component separator with a thickness of 14 μm. A schematic drawing showing the section structure of this separator is given in FIG. 6. The peel strength of the resin film with respect to the porous structure was 17 g/20 mm.

When the obtained electronic component separator was observed by an electron microscope, both sides of the separator were connected via many pores in the porous structure as well as pores comprising through pores, and the diameters of individual pores were smaller than the thickness of the microporous film. The distribution of pore diameters in the porous structure was consistent in the thickness direction of the separator, confirming a uniformity of the porous structure in the thickness direction. The average diameter of these pores as measured by the bubble point method was 6.2 μm, from which the primary average size of polyethylene grains was calculated as 80.6% of the pore diameter of the separator.

### Example 19

Two pieces of the separator obtained in Example 18 were prepared, and 0.5 g/m² of polyethylene grains similar to those used in Example 11 were retained on the side of each separator on which a porous film was not formed. The two separators were placed on top of each other in such a way that the two porous films, each comprising a porous structure, were exposed and that the through pores in both separators were offset from one another. This separator assembly was then heated and pressed to obtain an electronic component separator. The film thickness of this separator was 34 μm. A schematic drawing showing the section structure of this separator is given in FIG. 7.

### Example 20

One piece each of the separators obtained in Examples 11 and 18 were prepared. The separators were placed on top of each other in such a way that the phases of their through pores were offset, as shown in FIG. 8, and then heated and pressed to obtain an electronic component separator with a film thickness of 34 μm. The center of the obtained electronic component separator had a porous layer comprising a porous structure, which was different from the separator obtained in Example 19.

### Comparative Example 4

A stretched porous polyethylene film with a thickness of 20 μm was used as a comparative electronic component separator.

### Comparative Example 5

A stretched porous polyethylene film with a thickness of 10 μm was used as a comparative electronic component separator.

The characteristics of the separators obtained in the aforementioned examples and comparative examples, when used in a lithium ion secondary battery, were evaluated as follows.

[Ion Conductance]

Ion conductance was evaluated on each of the aforementioned separators. To measure ion conductance, a coin-shaped cell was produced from each of the aforementioned separators. The results are shown in Table 4. The measuring environment and equipment used are as follows:

Measuring environment: 20° C., 50% RH

Measuring equipment: SI 1287 1255 B manufactured by Solartron

TABLE 4

| | Ion conductance σ (S/cm) |
|---|---|
| Example 11 | 7.10 × 10⁻³ |
| Example 12 | 3.12 × 10⁻³ |
| Example 13 | 4.18 × 10⁻³ |
| Example 14 | 8.12 × 10⁻³ |
| Example 15 | 7.24 × 10⁻³ |
| Example 16 | 5.02 × 10⁻³ |
| Example 17 | 5.55 × 10⁻³ |
| Example 18 | 6.56 × 10⁻³ |
| Example 19 | 5.45 × 10⁻³ |
| Example 20 | 4.61 × 10⁻³ |
| Comparative Example 4 | 6.12 × 10⁻⁴ |
| Comparative Example 5 | 4.89 × 10⁻⁴ |

As evident from Table 4, the electronic component separators obtained in Examples 11 through 20 exhibited superb ion conductance. Reasons behind these good ion conductance levels include a low air permeability of the separator, and through formation on the separator of a resin layer comprising a porous structure, absence of gaps between the electrode and separator that are closely contacting via the resin layer provided on the separator surface. Also, all of the separators conforming to the present invention, as obtained in Examples, exhibited good roll performance, suggesting an equivalent or greater tensile strength compared with polyethylene separators. Comparative Examples 4 and 5 resulted in poor ion conductance.

[Shutdown Property]

Shutdown property was evaluated on each of the aforementioned separators. To measure shutdown property, a coin-shaped cell was produced from each of the aforementioned separators.

The results are shown in Table 5. As for the test method, each coin-shaped cell that had been fully charged was further charged, and the temperature change that occurred in the battery was measured. The shutdown temperature was defined as the point at which the temperature began to drop.

TABLE 5

| | Shutdown temperature (° C.) |
|---|---|
| Example 11 | 111 |
| Example 12 | 115 |
| Example 13 | 121 |
| Example 14 | 116 |
| Example 15 | 134 |
| Example 16 | 137 |
| Example 17 | 136 |
| Example 18 | 112 |
| Example 19 | 110 |
| Example 20 | 111 |
| Comparative Example 4 | 134 |
| Comparative Example 5 | 144 |

As evident from Table 5, the electronic component separators conforming to the present invention had a shutdown property, which would contribute to battery safety. In the series of examples conforming to the present invention, the gaps between grains and through pores or those between grains and pores in the porous structure were large enough not to suppress the growth of micro dendrite. Therefore, micro dendrite grew in these gaps and suppressed uncontrollable battery reaction due to overcharging. Also, these separators had a sufficient amount of grains to initiate a shutdown, which allowed the shutdown function to activate roughly simultaneously upon occurrence of minor short-circuiting caused by micro dendrite. It is assumed that these effects provided dual safety functions.

As explained above, all of the separators conforming to the present invention, as obtained in Examples, exhibited both sufficient ion conductance and safety. On the other hand, none of the separators obtained in Comparative Examples satisfied both characteristic requirements, and some even exhibited poor mechanical strength. In other words, none of the comparative separators satisfied the requirements under all of the above evaluation items.

[Dimensional Stability Under Heat]

The separators obtained in the examples and comparative examples were further examined with respect to their dimensional stability under heat, based on the procedure explained below. Specifically, each separator was cut to a square of 5 cm×5 cm in size and then sandwiched between two transparent, smooth glass plates, each sized to a square of 7 cm×7 cm and 10 mm in thickness. Then, the assembly was left for 24 hours in a dryer controlled at 160° C. The area after heating was obtained, and the ratio of the obtained area to the original area (=25 cm²) was evaluated as the rate of area reduction. Specifically, the rate of area reduction was calculated by (Area after heating/Area before heating)×100 (%)). The results are shown in Table 6.

TABLE 6

| | Rate of area reduction % |
|---|---|
| Example 11 | 98 |
| Example 12 | 98 |
| Example 13 | 99 |
| Example 14 | 98 |
| Example 15 | 97 |
| Example 16 | 97 |
| Example 17 | 98 |
| Example 18 | 98 |
| Example 19 | 98 |
| Example 20 | 98 |
| Comparative Example 4 | 56 |
| Comparative Example 5 | 45 |

From the above results, all of the separators conforming to the present invention, as obtained in Examples, exhibited very good dimensional stability under heat and caused little shrinkage at 160° C., which is a temperature above a normal shutdown temperature. This means the separator dimensions would remain unchanged even when the battery temperature rises to the shutdown temperature or above, thus preventing the electrodes from making direct contact with each other in the battery. Consequently, the separators conforming to the prevent invention exhibited very high safety in a high-temperature range compared with the separators in Comparative Examples 4 and 5 or conventional polyethylene separators.

### Example 21

An active material comprising 100 parts by weight of LiCoO₂, 10 parts by weight of graphite and 7 parts by weight of polyvinylidene fluoride resin was dispersed in N-methylpyrrolidone, and then the mixture was mashed in a mortar to prepare a paste. The obtained paste was applied on an aluminum foil using an applicator and dried for 45 minutes at 70° C. to a half-dry state, after which the active layer was pressed to 80% of the thickness of the half-dry active material right after coating. Thereafter, the active layer was dried for additional 5 hours at 60° C. to obtain a positive electrode.

A separator was formed on the obtained active positive electrode layer in the same manner as in Example 1 to obtain an electrode-integrated separator.

### Example 22

One hundred parts by weight of graphite grains and 5 parts by weight of polyvinylidene fluoride resin were mixed into a paste in the same manner as in Example 21, and the obtained paste was applied on a copper foil, after which the coated foil was dried, pressed and dried again in the same manner as in Example 21 to obtain a negative electrode.

A separator was formed on the obtained active negative electrode layer in the same manner as in Example 1 to obtain an electrode-integrated separator.

The present application claims priority under 35 U.S.C. § 119 to Japanese Patent Application No. 2004-080295, filed Mar. 19, 2004, and No. 2004-112702, filed Apr. 1, 2004, the disclosure of which is incorporated herein by reference in their entirety.

1. An electronic component separator comprising a porous base made of a substance having a melting point of 180° C. or above, and a resin structure provided on at least one side of and/or inside the porous base, and containing filler grains.

2. The electronic component separator as described in claim 1, wherein said porous base is a non-woven fabric or netlike substance comprising one or more of polyester, acrylic, polyamide, polyimide, vinylon, polyethylene naphthalate, cellulose, glass, ceramics and metal.

3. The electronic component separator as described in claim 1, wherein said porous base is a microporous resin film that only has through pores formed in the direction vertical to the film surface in a manner virtually free from any shielding structure between one side of the film and the other side.

4. The electronic component separator as described in claim 1, wherein said resin structure is a porous resin structure.

5. The electronic component separator as described in claim 4, wherein said porous resin structure has many pores linked together to connect one side of the separator to the other side, with each pore having a diameter smaller than the thickness of the porous base.

6. The electronic component separator as described in claim 1, wherein the resin comprising said resin structure has a melting point of 145° C. or above.

7. The electronic component separator as described in claim 6, wherein the resin composing said resin structure is made of one or more of polyvinylidene fluoride, vinylidene fluoride copolymer, polyacrylonitrile, acrylonitrile copolymer, poly(methyl methacrylate), methyl methacrylate copolymer, polystyrene, styrene copolymer, polyethylene oxide, ethylene oxide copolymer, polyimide amide, polyphenylsulfone, polyethersulfone, polyether etherketone and polytetrafluoroethylene.

8. The electronic component separator as described in claim 4, wherein the resin composing said resin structure is soluble in amide solvents, ketone solvents or furan solvents.

9. The electronic component separator as described in claim 1, wherein said filler grains have a melting point of 180° C. or above or virtually no melting point.

10. The electronic component separator as described in claim 1, wherein the electronic component is a lithium ion secondary battery, polymer lithium secondary battery, aluminum electrolytic capacitor or electric double-layer capacitor.

11. The electronic component separator as described in claim 1, wherein said porous base is a microporous resin film that has through pores with an average diameter of 50 μm or less running through the film in the direction vertical to its surface in a manner virtually free from any shielding structure and providing an average minimum distance of 100 μm or less between adjacent through pores; a resin structure is provided on at least one side of and/or inside the film; and filler grains are contained.

12. The electronic component separator as described in claim 11, wherein said microporous resin film has 50 g/m² or less of filler grains contained at its surface and/or on the inside, with the primary average size of said filler grains adjusted to 0.1 to 95% of the diameter of through pores.

13. The electronic component separator as described in claim 11, wherein a porous structure having pores with an average diameter of 0.1 to 15 μm is formed on at least one side of said microporous resin film and/or inside through pores.

14. The electronic component separator as described in claim 11, wherein 50 g/m₂ or less of filler grains are contained on at least one side of and/or inside said microporous resin film and porous structure, with the primary average size of said filler grains adjusted to 0.1 to 95% of the diameter of through pores or pores, whichever is smaller.

15. The electronic component separator as described in claim 11, wherein said microporous resin film comprises any one of polyester, polyimide and polytetrafluoroethylene.

16. The electronic component separator as described in claim 15, wherein the polyester used is polyethylene terephthalate.

17. The electronic component separator as described in claim 11, wherein said microporous resin film has a laminated structure comprising two or more films arranged in such a way that said through pores of respective films do not connect through in the vertical direction.

18. The electronic component separator as described in claim 11, wherein said filler grains are made of polyethylene and/or polypropylene.

19. An electrode-integrated electronic component separator comprising a porous base made of a substance having a melting point of 180° C. or above, and a resin structure provided on at least one side of and/or inside the porous base, and containing filler grains, which are being formed on top of an active electrode layer comprising a collector and an active layer, and having a separator.

20. A method for producing electronic component separator, wherein a porous base made of a substance having a melting point of 180° C. or above is coated with a coating material that contains a resin for forming a porous resin structure; and then the coating layer is dried to form a porous resin structure on the surface of and/or inside said porous base.

21. The method for producing electronic component separator as described in claim 20, wherein a microporous resin film is used as the porous base.

22. The method for producing electronic component separator as described in claim 20, wherein a porous base, made of a substance having a melting point of 180° C. or above and on which filler grains are retained, is placed on a retainer material; a coating material that contains a resin for forming a porous resin structure is applied on top; the coating layer is dried to form a porous resin structure on the surface of and/or inside the porous base; and then the retainer material is removed.

23. The method for producing electronic component separator as described in claim 20, wherein a coating material that contains a resin for forming a porous resin structure is applied on a retainer material to form a coating layer; a porous base, made of a substance having a melting point of 180° C. or above and on which filler grains are retained, is placed on top of said coating layer; the coating layer is dried to form a porous structure on the surface of and/or inside the porous base; and then the retainer material is removed.

24. The method for producing electronic component separator as described in claim 22, wherein a resin film with a peel strength of 0.1 to 75 (g/20 mm) with respect to the porous resin structure is used as the retainer material.

25. The method for producing electronic component separator as described in claim 23, wherein a resin film with a peel strength of 0.1 to 75 (g/20 mm) with respect to the porous resin structure is used as the retainer material.

26. The method for producing electronic component separator as described in claim 20, wherein the coating material for forming said porous resin structure contains at least one type of good solvent capable of dissolving the resin composing the porous resin structure and at least one type of poor solvent incapable of dissolving said resin.

27. The method for producing electronic component separator as described in claim 26, wherein said poor solvent is removed into air only by way of drying.

28. The method for producing electronic component separator as described in claim 20, wherein the water content of said coating material is 0.7 percent by weight or less as measured by the Karl Fischer method.

29. A method for producing electronic component separator, wherein a porous base made of a substance having a melting point of 180° C. or above is coated with a coating material that contains a resin for forming a porous resin structure; and then the coating layer is dried to form a porous resin structure on the surface of and/or inside said porous base.

30. A method for producing electrode-integrated electronic component separator comprising a process of placing on an active electrode layer comprising of a collector and an active layer, a porous base made of a substance having a melting point of 180° C. or above and on which filler grains are retained; a process of applying on said porous base a coating solution that contains a binder resin and its good solvent and poor solvent; and a process of drying the formed coating layer and removing the solvents to form a porous structure on the surface of and/or inside the porous base.
